(19) United States
(12) Patent Application Publication
(10) Pub. No.: US 2009/0147264 A1
(43) Pub. Date: Jun. 11, 2009

(54) LABEL-FREE, REAL-TIME DETECTION SYSTEM FOR MOLECULAR INTERACTION ANALYSIS

(75) Inventor: Michael T. LOTZE, Pittsburgh, PA (US)

Correspondence Address: FOLEY AND LARDNER LLP;SUITE 500, 3000 K STREET NW, WASHINGTON, DC, 20007, US

(73) Assignee: The University of Pittsburgh - Of the Commonwealth System of Higher Education

(21) Appl. No.: 12/111,363

(22) Filed: Apr. 29, 2008

Related U.S. Application Data
(60) Provisional application No. 60/924,074, filed on Apr. 30, 2007.

(51) Int. Cl. G01B 9/02; G01N 21/55

(52) U.S. Cl. 356/477; 356/445; 356/491; 356/450

(57) ABSTRACT

An approach to diagnosing various physiological conditions in a subject entails determining the presence and, optionally, the amount or concentration of cell-free DNA in a sample from the subject. For this purpose one can employ an element that includes an optical surface with DNA-binding molecules immobilized thereon, where the optical surface is adapted for an optical instrument configured to detect DNA bound by the surface-immobilized molecules. Accordingly, one can diagnose in the subject a disease or other physiological condition by (A) contacting a sample from the subject with DNA-binding molecules and then (B) determining optically whether DNA has bound to the DNA-binding molecules, consequent to contacting the sample.

### CROSS-REFERENCE TO RELATED APPLICATIONS

The present application claims priority to U.S. provisional application No. 60,924,074 “Label-free, real-time detection system for molecular interaction analysis” filed Apr. 30, 2007 to Michael Lotze.

### BACKGROUND OF THE INVENTION

There is substantial evidence that DNA in body fluids is associated with adverse prognosis in several clinical conditions, including cancer and systemic lupus erythematosus, among others. More generally, cell-free DNA is a member of the class of so-called “damage-associated molecular pattern molecules” (DAMPs), which are released into the cell-free environment upon necrotic cell death, for instance, by dying tumor cells. See Lotze and DeMarco, Curr. Opin. Investig. Drugs 4: 1405-9 (2003); Zeh & Lotze, J. Immunother. 28: 1-9 (2005). The presence of DAMPs locally and in the systemic circulation leads to activation of innate immune effectors and the establishment of a chronic inflammatory state that favors tumor progression, growth, and metastases Vakkila et al., Nat. Rev. Immunol. 4: 641-8 (2004); Demarco et al., Molec. Immunol. 42: 433-44 (2005); Lotze et al., Nat. Rev. Immunol. 5: 331-42 (2005). DNA is abundant in all nucleated cells. Therefore, its release upon cell death serves as an important biomarker for both acute and chronic tissue damage.

Accordingly, the presence of cell-free DNA is an important cue for a potential disease or pathological state. Early detection of cell-free DNA in biological samples would enable quicker diagnoses and more appropriate interventions, therefore, especially if the approach could be implemented at the site of care in an inpatient or outpatient facility.

### SUMMARY OF THE INVENTION

To this end, the present invention couples to an optical or other sensor surface a DNA-binding molecule, such as a protein of the HMGB superfamily or an artificial variant that incorporates the HMG domain, thereby to provide a rapid, label-free approach to measuring and distinguishing DNA subspecies in complex mixtures, including serum, plasma, and other biofluids. One can exploit this approach, employing a standard curve with known DNA, to quantitate the amount of DNA in such a biofluid. The invention also contemplates the use of adducts, such as platinum compounds, to increase DNA binding to the sensor surface, enhancing detection.

In accordance with one of aspect of the invention, therefore, an optical dielectric element is provide that comprises a transparent material and that presents a first reflecting surface and a second reflecting surface, wherein the first reflecting surface supports a layer comprised of a DNA-binding molecule and the second reflecting surface lacks such a layer. The first and second reflecting surfaces preferably are separated by at least 50 nm, and the element can be configured for coupling to a light source via a fiber. In one embodiment of the invention, the optical dielectric element has a waveguide structure comprised of (i) a primary waveguide that presents the first reflecting surface and (ii) a secondary waveguide that presents the second reflecting surface, such that the refractive index of the primary waveguide diverges from that of the secondary waveguide upon binding of a DNA species onto the aforementioned layer by the DNA-binding molecule.

In accordance with another aspect of the invention, an interferometer is provided that comprises (A) an optical dielectric element as described above and (B) a light source operatively linked to that element. The invention also contemplates at method for assaying the presence of a DNA species in a mixture, comprising: (A) providing an interferometer as described, such that interference between a reflected beam from the first reflecting surface and a reflected beam from the second reflecting surface varies upon binding of the DNA species onto the layer by the DNA-binding molecule; (B) then exposing said optical dielectric element to the mixture; and (C) determining whether a change occurs in the interference between the reflected beams, whereby such a change is indicative of the presence in the mixture of the DNA species.

In accordance with a further aspect of the invention, a methodology is provided for diagnosing a physiological condition in a subject, comprising
(A) obtaining a sample of a body fluid from the subject;
(B) providing DNA-binding molecules on a surface;
(C) bringing that surface into contact with the sample under conditions that are permissive of binding of DNA by the DNA-binding molecules;
(D) optically detecting whether a DNA binding occurs upon this contact; and
(E) effecting a diagnosis for the subject based a result from step (D).

This methodology of the invention can entail the use, in step (D), of interferometry, such as dual polarization interferometry, ellipsometry, or surface plasmon resonance spectrometry. Step (C) of the inventive methodology preferably comprises adding a binding-enhancing agent, such as a binding-enhancing agent that comprises platinum.

### BRIEF DESCRIPTION OF THE DRAWINGS

FIG. 1 illustrates measurement of the amount of cell-free DNA using “biolayer interferometry,” in accordance with the present invention.

FIG. 2 presents data showing the binding of DNA to HMGB1 on a silicon oxynitride chip and detection using dual polarization interferometry.

### DETAILED DESCRIPTION OF THE PREFERRED EMBODIMENTS

The present inventor has developed a novel approach to diagnosing a physiological condition in a subject, based on determining an amount or concentration of cell-free DNA in a sample from the subject. The invention thus provides, in accordance with one of its aspects, a method for diagnosing in a subject a disease or other physiological condition, by (A) contacting a sample from the subject with DNA-binding molecules and then (B) determining optically an amount or concentration of DNA bound to the DNA-binding molecules upon contacting the sample, thereby to inform a diagnosis of the physiological condition based on the determined amount of the DNA bound in this manner.

The present invention also contemplates an element that includes an optical surface with DNA-binding molecules immobilized thereon, where the optical surface is adapted for an optical instrument configured to measure an amount or concentration of DNA bound to the surface-immobilized, DNA-binding molecules. The type or format of the optical surface depends in part on the optical instrument employed for this purpose. As discussed in greater detail below, when the optical instrument is an ellipsometer, for instance, the optical surface is a specularly reflecting surface. Alternatively, when the optical instrument is a surface plasmon resonance apparatus, then the optical surface is a surface of a thin metallic film deposited on a dielectric optical element, such as prism.

In certain of its embodiments, the present invention provides a biosensor that is characterized by a surface chemistry modified to exploit an amide-coupled DNA-binding protein, illustrated by HMGB1, to bind DNA with high affinity, on the order of 10⁻¹² M. This binding is preferably detected optically, by measuring shifts in the phase of white light reflected, e.g., at the end of a fiber optic cable. In that instance, the phase shift is caused by a mismatch between the refractive index of the cable and the solution.

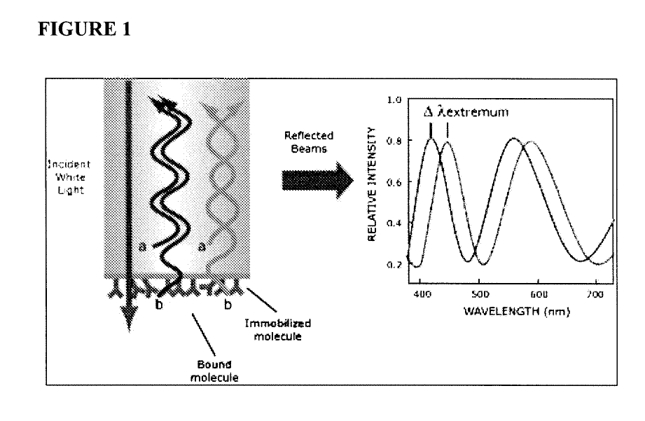

Detection and quantitation of the mismatch may be effected, for instance, by means of biolayer interferometry (BLI) or dual-polarization interferometry (DPI), although these are simply representative of the range of optical platforms that can be employed to this end, pursuant to the invention. BLI measures the shift in the reflected interference pattern, propagated by white light, between the surface of a biosensor tip and a bound molecule. As shown in FIG. 1, the shift results in both constructive and destructive interference patterns. Only molecules binding to or dissociating from the biological layer can shift the wavelength of the interference pattern and generate a response profile, in nanometer units. On the other hand, DPI measures the structure of a protein by determining its thickness and refractive index. DPI uses orthogonal polarized light from a laser via transverse electric (TE) and transverse magnetic (TM) light waves, passing through a waveguide on an AnaChip™ surface. Variations in the inference pattern are caused by changes in the structure and/or mass of the immobilized molecules. Thus, DPI provides information indicative of structural changes taking place in molecular systems as they function and interact.

### DNA-Binding Molecules

Pursuant to the present invention, a DNA-binding molecule can be selected for the purpose of detecting DNA by coupling the molecule to an optical instrument, as described above and exemplified below. The category of “DNA-binding molecules” is characterized by an affinity for DNA and includes, without limitation, a diversity of oligomers, proteins, carbohydrates, and other nucleic acids.

The choice of the DNA-binding molecule to use will depend on the type of DNA detection desired. For instance, a DNA-binding molecule could be selected, pursuant to the invention, that binds to DNA non-specifically, i.e., in a manner that is not dependent on the nucleotide sequence of the DNA target. By means of a non-specific DNA-binding molecule, therefore, an optical device of the invention could detect cell-free DNA, also known as “damage-associated DNA,” in the serum of a subject.

There are numerous non-specific DNA-binding molecules known, and others undoubtedly will come to light, which can be candidates for use in the present invention. Illustrative of such molecules that bind DNA in situ are chromatin-associated proteins, such as histones (H1, H2A, H2B, H3, H4) and proteins that comprise the high-mobility-group (HMG) domain. See Klass et al., Nucleic Acids Res. 31: 2852-64 (2003).

Approximately 80 amino acid residues in length, the HMG domain defines the HMGB superfamily, which has two sub-families that are distinguished, in part, by DNA specificity. An archetype of the superfamily is HMGB1, which has been shown to have a high affinity for the cell-free DNA. For example, see Muller et al., Biochemistry 40: 10254-61 (2001). Part of the HMGB superfamily, too, are the Sox proteins, characterized by reference to the sex-determining region of the Y chromosome (Sry), where the encoding genes generally map. See Weiss, Molec. Endocrinol. 15: 353-62 (2001).

DNA-binding molecule candidates for the invention can be drawn as well from other families of proteins with substantially non-specific DNA-binding properties, such as: (i) the ARID (A-T Rich Interaction Domain) family proteins, see Patsialou et al., Nucleic Acids Res. 33: 66-80 (2005); (ii) the protein groups that are defined by the presence of a structural motif, such as the SAF-Box, that binds to the so-called “scaffold attachment regions” (SARs) of eukaryotic genomes, see Kipp et al., Molec. Cell. Biol. 20: 7480-89 (2000); and (iii) the Maf family proteins, characterized by the Maf extended homology region (EHR), see Kusunoki et al., Nature Struct. Biol. 9: 252-56 (2002).

In each instance, one can employ a natural protein as the DNA-binding molecule of the invention, as noted. Alternatively, an artificial peptide oligomer can be used that comprises one or more of the typifying binding domains, as discussed above, to impart the requisite affinity for free DNA. The production of such peptide oligomers would employ conventional methodology as detailed, for instance, by Benoiton, N. L., CHEMISTRY OF PEPTIDE SYNTHESIS (CRC Press, 2006). An example of a DNA-binding peptide is one comprising a leucine zipper motif, i.e., an α-helical domain shown to bind the major groove of the DNA double helix. See O'Neil et al., Science 249: 774-78 (1990). In particular, proteins that are responsive to stress states may be used as the DNA binding molecule. Illustrative in this regard are: Gcn4p, a transcriptional activator, which induces the expression of genes that are involved in amino acid and purine biosynthetic pathways under amino acid starvation; the Homer family of proteins capable of binding other proteins with DNA binding domains; combinations of binding proteins, such as ChREBP and Mlx, which heterodimerize to bind DNA; and proteins such as SARP (several ankyrin repeat protein), an alternatively spliced protein phosphatase 1 and DNA-interacting protein, which like HMGB1, are highly abundant in the nucleus of mammalian cells. See Seong et al., J. Microbiol. Methods (published online Feb. 28, 2007); Shiraishi-Yamaguchi et al., Genome Biol. 8: 206 (2007); Ma et al., Nucleic Acids Res. 35: 35-44 (2007); Browne et al., Biochem J. 402: 187-96 (2007).

Also in the category of non-specific DNA-binding molecules are RNA and DNA aptamers, replication factors, and DNA modifying proteins, such as polymerases, topoisomerases, and nucleases. General transcription factors (e.g TATA binding protein and TFIID) also may be employed. Even though general transcription factors typically bind to certain promoter elements, they are not gene-specific and may recognize a plurality of nucleic acids in a sample. Furthermore, if the target is single-stranded DNA (ssDNA), then ssDNA-binding protein could be used for non-specific binding, in accordance with the invention.

The category of DNA-binding molecules also encompasses various chemical agents capable of binding DNA, such as ferroceneacetyl naphthelene diimide See Sato et al., Nucl. Acids Symp. Ser. 44: 171-72 (2000). Additionally, chemical agents with sequence reading, intercalating, or alkylating activity can be suitable DNA-binding molecules. See Pindur et al., Curr. Med. Chem. 12: 2805-47 (2005). Various chemistries are available to immobilize such agents to the optical surface, as discussed above, including but not limited to binding via thiol groups or amino groups and direct physisorption onto the silica surface.

Alternatively, it may be desirable for the DNA-binding molecule employed in the invention to bind DNA having a specific sequence of nucleotides. Detecting DNA in this way would be most useful when it is necessary to determine the presence or absence of a specific sequence of nucleotides (e.g., a particular gene or allele) in a sample. Examples of DNA-binding molecules that exhibit sequence specificity include but are not limited to (a) single stranded oligonucleotides complementary to the desired sequence (b) transcription factors that have an affinity for a specific nucleotide sequence, (c) restriction enzymes from prokaryotes or metazoan sources, and (d) topoisomerases or recombinases such as Cre or RAG1/2.

The detection of DNA binding to a DNA-binding molecule can be enhanced via any of several techniques. Pursuant to the invention, larger changes in the aforementioned refractive index mismatch increase the sensitivity of measurements. Platinated oligonucleotides are characterized by a high electron density, which changes the real part of the interfacial refractive index, and by an absorbance at the blue end of the spectrum, which changes the imaginary part of the interfacial refractive index. The overall result is a larger change in refractive index mismatch, relative to non-plantinated forms, and this provides enhanced sensitivity in the optical biosensor of the invention.

Platination of solution oligonucleotides also increases the strength of the HMGB1-oligo interaction. See McA'Nulty et al., Biochemistry 35: 6089-99 (1996) (platination changed the dissociation constant for DNA and a yeast analogue of HMGB1 from 2.0×10⁶ M for the unplatinated DNA to 2.5×10⁷ M). This affinity increase is due to direct Pt-HMGB1 interactions, which in turn affords further increases in sensitivity for an inventive optical biosensor, in measuring the DNA content of complex serum samples.

Suitable for use in this fashion are any of the platinums that are approved for clinical use, such as cisplatin, carboplatin, and oxaliplatin. Any other plantinums that enhance DNA binding may be used, including those that may become available on the strength of future clinical or diagnostic testing.

Accordingly, it is a key aspect of the invention to discern damage-associated DNAs by their binding of HMGB1 or another macromolecule, such as a transcription factor, histone, or an RNA or a DNA aptamer, or chemical agent, that can bind DNA with high affinity, where such a binding is preferably detected optically and preferably in real time. By this approach it is possible to obtain diagnostically useful information, in a clinical setting, that relates to acute inflammatory conditions, such as those associated, respectively, with trauma and infectious diseases, and to chronic inflammatory disease states relating, for instance, to cancer, atherosclerosis, obesity, chronic viral and bacterial infections, and autoimmune conditions, such as graft-versus-host/host-versus-graft, inflammatory bowel disease, systemic lupus erythematosus, and rheumatoid arthritis, all of which are associated with the presence of cell-free DNA.

### Detection of Cell-Free DNA in a Biosensor

In accordance with the invention, the amount of cell-free DNA preferably is determined via an optical technique, as mentioned above. It also is preferred that the optical technique be “label-free,” meaning that it does not require the attachment to the cell-free DNA of a radioactive, fluorescent, or other label.

In some embodiments, the label-free optical method that is employed can detect changes upon exposure to the sample in optical and/or physical properties of a film, which is disposed on a surface and which contains or presents DNA binding molecules. Illustrative of label-free techniques are interferometry, surface plasmon resonance, and ellipsometry.

A. Interferometry

Interferometry is a technique based on measurement of a light intensity produced by an interference of two or more light beams. Interferometry can be used for detecting optical properties, such as a refraction index, and physical properties, such as thickness, of a thin film when a difference between the light beams is due to the light passing through the thin film. Experimental configurations for interferometry include but are not limited to reflection and transmission configuration. For example, for a thin film disposed on a substrate, two interfering beams in the reflection mode can be (1) a beam passing through the thin film and reflecting from an interface between the substrate and the film and (2) a beam reflecting from an interface between the thin film and the air. If the substrate is optically transparent, an interference can be measured in a transmission mode as well. Two interfering beams in this case can be (i) a beam passing through the thin film and the substrate without any reflections and (ii) a beam passing through the thin film; reflecting at an interface between the thin film and the substrate; reflecting back at the interface between the thin film and the air, and then passing through the substrate.

As applied for the present invention, interferometry can be used for detecting a change in thickness of an organic film, comprised of DNA-binding molecules, consequent to exposure to the biological sample, and thereby for determining the amount of cell-free DNA in the sample from the detected change in thickness. In some embodiments, an interferometric apparatus for determining the amount of cell-free DNA in the sample can be a fiber-optic assay apparatus disclosed in US patent publication No. 2005/0254062. Such an apparatus is available commercially from Fortebio, Inc. (Menlo Park, Calif.). The type of interferometry disclosed in US patent publication No. 2005/0254062 is commercialized by Fortebio as Biolayer Interferometry (BLI).

FIG. 1 illustrates principle of operation for BLI. In FIG. 1, interfering light beams originate from 1) the interface with the optical layer (a) and from the surface of the biocompatible layer comprising immobilized molecules (b) where the biocompatible layer meets the surrounding solution. The light beam can interact constructively or destructively as respectively demonstrated by the left two waves and the right two waves on the left panel of FIG. 1. Binding of molecules from the solution will change optical properties and/or thickness of the biocompatible layer and will result in changes in the interference pattern.

For the present invention, the biocompatible layer used for BLI can be a film comprising immobilized DNA-binding molecules, and molecules in the solution binding to the biocompatible layer can be molecules of cell-free DNA, as described above. Several methods can be used to immobilize the DNA binding molecule to the biocompatible layer. For example amide-linkage chemistries, including ester or thio ester strategies. Oligomers may be attached at their terminal ends to the chip surface. Methods for synthesizing oligomers containing hydroxy acids, other monomers, or oligomers such as amino acids, carbohydrates, peptides, nucleotides are well-known in the art. The oligomers can have a C, O, S or N-terminal end, binding at either the C-terminal or O, S or N-terminal end to the chip surface. The bond to the chip surface can be an amide, thioester, ester, phosphate, silyl ether, carbamate, benzyl ether, or other linkage.

In some embodiments, an interferometric apparatus of the invention can be one where an interference is created between light beams passing through two or more identical waveguides. Such waveguides can be waveguides as disclosed, for instance, in U.S. Pat. No. 7,062,110, No. 7,050,176, No. 6,701,032, and No. 6,335,793. In such configuration, one of the waveguides can act as a reference and another of the waveguides can be a test waveguide. Such an interferometric apparatus can measure a change in thickness and optical properties of the thin film disposed on the outer surface of one of waveguides.

For the present application, the waveguide interferometric apparatus can have a thin film, comprised of DNA-binding molecules, that is disposed on one of the waveguides, and a measurement of changes in the thickness of the film upon an exposure to the biological sample can be used for determining the amount of cell-free DNA in the sample. The interferometric apparatus with two identical waveguides can function in dual polarization interferometry mode, i.e., a polarizer switching between p- and s-polarization (TE and TM modes) can be placed on a common optical path of two beams between a light source and a detector. Dual polarization interferometry apparatus is available commercially from Farfield Scientific Limited (Cheshire, U.K.).

As noted, the present invention allows for the extraction of quantitative information about the amount or concentration of cell-free DNA in a biological sample. Using an interferometric technique to this end, for instance, one preferably would calibrate a biosensor of the invention, comprising DNA-binding molecules as described above, using a calibration sample with a known concentration of DNA.

B. Ellipsometry

Ellipsometry is a technique that measures a change in polarization that an incident, polarized beam of light experiences upon reflection from a specular surface. Ellipsometry can be used for determining optical properties, such as refraction coefficient, and physical properties, such as thickness, of thin organic films disposed on the specular surface. Principles of ellipsometry and related applications for measuring properties of thin films is detailed, for example, in Collins, R. W. et al., “Spectroscopic Ellipsometry,” in CHARACTERIZATION OF ORGANIC THIN FILMS 35-55 (Butterworth-Heinemann, 1995). In the present application, ellipsometry can be used for measuring, upon an exposure to the sample from the subject, a change in thickness and/or optical properties of a thin film comprised of DNA-binding molecules.

Typical ellipsometer includes at least the following components: a light source, a detector, a polarizer positioned on the optical path between the light source and the sample of study; an analyzer, which is a polarizer positioned on the optical path between the sample of study and the detector. Real-time ellipsometers are available commercially from J. A. Woolham Co., Inc., among others.

For the present application, ellipsometry can be applied for measuring a change in optical properties, such as refractive index, and/or thickness in a thin organic film that is disposed on the specular surface and contains DNA-binding molecules, upon exposure to the biological sample. From the measured change, the amount or concentration of cell-free DNA in the sample can be extracted.

C. Surface Plasmon Resonance

Surface Plasmon Resonance (SPR) is a technique based on a physical process that can occur when plane-polarized light hits a thin metallic film under total internal reflection condition. SPR can be used for detecting binding events that occur in an organic film deposited on the thin metallic film. In case of the present invention, such an organic film can comprise a DNA-binding molecules, and the binding events can be those between the cell-free DNA from the sample and the DNA-binding molecules. Details of SPR can be found, for example, in Biacore AB, TECHNOLOGY HANDBOOK (1998); Markey, Bio Journal 1: 14-17 (1999), and REAL-TIME ANALYSIS OF BIOMOLECULAR INTERACTIONS: APPLICATIONS OF BIACORE, Nagata, K. and Handa, H., eds, (Springer Verlag, 2000). Illustrative SPR instrumentation is commercially available from Biacore AB (Rapsgatan, Sweden).

To detect the amount of cell-free DNA, one first can obtain an SPR element, which includes a dielectric element and a thin metallic film deposited on the dielectric element; then form a thin organic film containing DNA binding molecules on a surface of the metallic thin film not facing the dielectric element; then expose the thin organic film to the sample and measure changes in an SPR signal upon the exposure.

The dielectric element can have any appropriate configuration capable to generate and measure surface plasmon resonance. For instance, the dielectric element can be a prism in an Otto or Kretchman configuration; a waveguide or a sinusoidal grating.

The thin metallic film can any a thin film of any metal capable to produce surface Plasmon effect. The thin metallic film can be gold or silver film, for example.

SPR measurement of SPR typically involves a measurement of angular dependence of intensity of p-polarized light reflected from an internal surface of the metallic thin film, i.e., a surface of the metallic thin film facing the dielectric element.

D. Quartz Crystal Microbalance

The present invention also encompasses non-optical label-free methodology, illustrated by the use of a quartz crystal microbalance (QCM), to determine the amount of cell-free DNA in the sample. QCM is a technique that measures a mass added to a piezoelectric quartz crystal by detecting a change in the frequency of the crystal. Quartz crystal microbalance systems are available commercially from Stanford Research Systems (Sunnyvale, Calif.).

Pursuant to this approach, one can dispose, on the surface of a piezoelectric crystal, a thin organic film comprised of DNA-binding molecules, and then expose the film to the sample. By measuring whether the exposure occasions a change in the frequency of the piezoelectric crystal, it is possible to ascertain any change in thickness of the film and, as a function of such change, to extrapolate the amount of cell-free DNA in the sample.

### EXAMPLES OF THE PRESENT INVENTION

Biosensors of the invention, with HMGB1 as the DNA binding molecule, were employed to study nucleotide mixtures comprised of: (1) oligos and respective scrambled oligos; (2) circular DNA; (3) linear DNA; and (4) cisplatinated versus non-cisplatinated oligonucleotides. For each of these, subsequent binding of sRAGE, a soluble receptor for HMGB1, also was evaluated. The biosensor designs of the invention proved suitable for measuring hypomethylated CpG oligos and specially constructed oligonucleotides, as well as linearized but not circular DNA. In addition, DNA bound to HMGB1 was able to bind sRAGE almost irreversibly, thereby opening the way to verify stoichiometric DNA binding and quantitation, pursuant to the invention. The addition of platinums (cis-platinum, carboplatinum, or oxaliplatin) enhanced DNA binding.

For purposes of illustration only, these examples employ two distinct platforms, ForteBio optical scanning (DPI) and Farfield interferometry (BLI), to demonstrate the effectiveness of the inventive approach with HMGB1. As noted above, the latter protein is prototypical of suitable DNA binding molecules, i.e., molecules that bind DNA with high affinity. With the guidance provided above, a person knowledgeable in molecular biology routinely could select other suitable DNA-binding molecules, including proteins, peptides, and other nucleic acids, for use in accordance with the present invention.

### Example 1

### Dual-Polarization Interferometry (DPI)-Based Detection of DNA

In accordance with the present invention, a DNA binding protein was bound to a silicon oxynitride chip (product of Farfield) and then used to detect DNA in a sample. Binding of HMGB1 to the chip was carried out as follows. First, a running buffer of PBS, 0.1 mM Ca²⁺, 0.1 mM Mg²⁺ at pH 7.4 was added. After chip/buffer calibration, 80% ethanol in H₂O was injected for 2 minutes at 24° C., followed by injection of BS3 linker (2 mg/ml in PBS) at 50 ml/min for 3 minutes. Recombinant HMGB1 (50 mg/ml in PBS) was then injected (Channel 1 only), at 75 ml/min for 1 minute and then 10 ml/min for 5 minutes. HMGB1 was immobilized predominantly in an up-right conformation with long-axis perpendicular to the amine-reactive surface, suggesting preferential attachment by the loop region of the protein. Electrostatic repulsion of the positive protein and positive surface of the chip directed the immobilized orientation.

BSA (2.2 mg/ml in PBS) was loaded in the second channel at 50 ml/min for 3 minutes. Poly-L-lysine (0.1 mg/mL) was used to block both channels. It was loaded at 75 ml/min for 1 minute, then 10 ml/min for 5 minutes, followed by ethanolamine to block reactive NHS groups in both channels. BSA (2.2 mg/ml in PBS) was loaded in the second channel at 50 ml/min for 3 minutes.

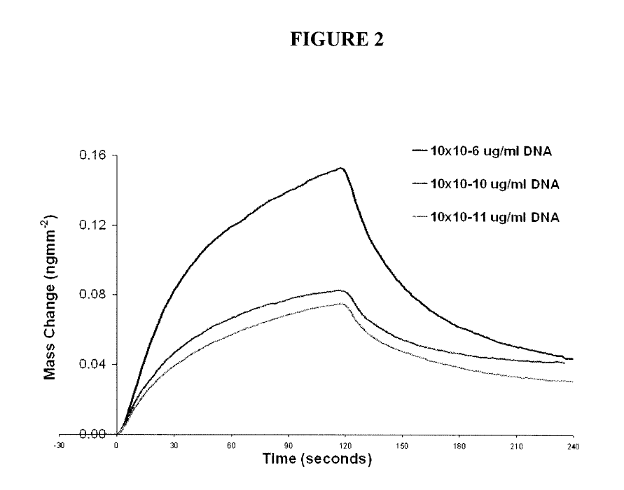

DNA interactions were assessed at various concentrations (10⁻⁶, 10⁻¹⁰, and 10⁻¹¹ μg/mL DNA), with flow at 75 ml/min for 2 minutes. FIG. 2 shows the mass changes detected by DPI upon binding DNA at different concentrations. DNA initially bound to HMGB1 and, over time, was dissociated by the PBS running buffer. The results demonstrate the ability of DPI, a coupled DNA-binding molecule, to detect DNA even at concentrations of 10⁻¹⁰ and 10⁻¹¹ μg/mL.

### Example 2

### Biolayer Interferometry (BLI)-Based Detection of DNA

In accordance with the present invention, a DNA binding protein (HMGB1) was bound to a biolayer sensor, adapted from ForteBio, in order to detect DNA in a sample. HMGB1 (25 μg/mL in MES, pH 5) was coupled to the chip surface by means of amide-linkage chemistry. A duplicate run was used, with BSA (pH 5.0) coupled to the chip. Various DNA molecules, all the same size, were tested for binding, including oligonucleotides and linear and circular DNA. The two novel hairpin oligonucleotides in this example included:

Oligo #1:
5′-CCTCTCTGGACCTTCC*T*T*T*T*GGAAGGTCCAGAGA*G*G
and
Oligo #2:
5′-CTGGACCTTCC*T*T*T*T*GGAAGGTCC*A*G,

in which asterisk (*) denotes a phosphorothioate linkage. These novel hairpin oligonucleotides were scrambled and used as a control. The sequences of the scrambled oligonucleotides were:

Scrambled #1:
5′-cTC CGA CGc tCA aTG cTG GTA CGG Tat CCG TgT
TAG-3′
and
Scrambled #2:
5′-GTA cGA agT CCG TTC cTa GGC tTG ct-3′.

TABLE 1
HMGB1 Binding to DNA

| | Affinity to | Affinity to |
|---|---|---|
| DNA | HMGB1 | RAGE |
| Scrambled 1 | 5.1e−8 | 8.7e−9 |
| Scrambled 1 + CP | 3.1e−8 | 5.6e−9 |
| Oligo 1 | 6.6e−9 | 8.7e−9 |
| Oligo 1 + CP | 1.3e−8 | 1.1e−8 |
| Scrambled 2 | 1.8e−7 | 3.9e−9 |
| Scrambled 2 + CP | 7.6e−9 | 3.7e−9 |
| Oligo 2 | 3.3e−8 | 4.3e−9 |
| Oligo 2 + CP | 7.0e−8 | 5.5e−9 |
| Circular | 3.6e−9 | 1.5e−8 |
| Circular + CP | 4.1e−9 | 1.4e−8 |
| Linear | 1.4e−11 | Tight |
| Linear + CP | 4.4e−12 | Tight |

As shown in Table 1, affinities of DNA to HMGB1 ranged from 1.8×10⁻⁷ to as much as 4.4×10⁻¹² for the various DNA preparations. The effect also was examined of binding by sRAGE (advanced glycation end-products receptor) to HMGB1 in the presence of DNA. sRAGE exhibits a high affinity for HMGB1 by itself, but an even greater affinity was observed when sRAGE and HMGB1 were in the presence of circular and linear DNA.

Furthermore, it was observed that the addition of cisplatin increases the affinity of the various DNAs to HMGB1. The enhancing effects of cisplatin on DNA binding were limited to the interaction DNA/HMGB1. No increased affinity was observed between sRAGE and HMGB1 in the presence of cisplatin. In accordance with the present invention, therefore, the addition of a platinum-compound to can enhance the detection of DNA in a sample.

Although the foregoing refers to particular preferred embodiments, it will be understood that the present invention is not so limited. It will occur to those skilled in the relevant art that various modifications may be made to the disclosed embodiments and that such modifications are intended to be within the scope of the present invention. All of the above-cited publications and patent documents are incorporated here by reference in their entirety.

What is claimed is:

1. An optical dielectric element that is comprised of a transparent material and that presents a first reflecting surface and a second reflecting surface, wherein said first reflecting surface supports a layer comprised of a DNA-binding molecule and said second reflecting surface lacks such a layer.

2. An optical dielectric element according to claim 1, wherein said first and second reflecting surfaces are separated by at least 50 nm.

3. An optical dielectric element according to claim 2, wherein said element is configured for coupling to a light source via a fiber.

4. An optical dielectric element according to claim 1, wherein said element has a waveguide structure comprised of (i) a primary waveguide that presents said first reflecting surface and (ii) a secondary waveguide that presents said second reflecting surface, such that the refractive index of the primary waveguide diverges from that of the secondary waveguide upon binding of a DNA species onto said layer by said DNA-binding molecule.

5. An interferometer comprising (A) an optical dielectric element according to any of claims 1-4 and (B) a light source operatively linked to said optical dielectric element.

6. A method for assaying the presence of a DNA species in a mixture, comprising:
(A) providing an interferometer according to claim 5, such that interference between a reflected beam from the first reflecting surface and a reflected beam from the second reflecting surface varies upon binding of said DNA species onto said layer by said DNA-binding molecule,
(B) exposing said optical dielectric element to said mixture; and
(C) determining whether a change occurs in the interference between the reflected beams, whereby such a change is indicative of the presence of said DNA species in said mixture.

7. A method of diagnosing a physiological condition in a subject, comprising
(A) obtaining a sample of a body fluid from the subject;
(B) providing DNA-binding molecules on a surface;
(C) bringing said surface into contact with the sample under conditions that are permissive of binding of DNA by the DNA-binding molecules;
(D) optically detecting whether a DNA binding occurs upon said contact; and
(E) effecting a diagnosis for the subject based a result from step (D).

8. The method of claim 7, wherein step (D) comprises the use of interferometry, ellipsometry, or surface plasmon resonance spectrometry.

9. The method of claim 8, wherein step (D) comprises the use of interferometry.

10. The method of claim 9, wherein step (D) comprises the use of dual polarization interferometry.

11. The method of claim 1, wherein step (C) comprises adding a binding-enhancing agent.

12. The method of claim 11, wherein the binding-enhancing agent comprises platinum.


SEQUENCE LISTING (4 sequences)

SEQ ID NO: 1 - DNA, 36 bp, Artificial Sequence
  Description of Artificial Sequence Synthetic oligonucleotide
cctctctggaccttccttttggaaggtccagagagg

SEQ ID NO: 2 - DNA, 26 bp, Artificial Sequence
  Description of Artificial Sequence Synthetic oligonucleotide
ctggaccttccttttggaaggtccag

SEQ ID NO: 3 - DNA, 36 bp, Artificial Sequence
  Description of Artificial Sequence Synthetic oligonucleotide
ctccgacgctcaatgctggtacggtatccgtgttag

SEQ ID NO: 4 - DNA, 26 bp, Artificial Sequence
  Description of Artificial Sequence Synthetic oligonucleotide
gtacgaagtccgttcctaggcttgct